(19) United States
(12) Patent Application Publication
(10) Pub. No.: US 2005/0274849 A1
(43) Pub. Date: Dec. 15, 2005

(54) Highly-integrated low-mass solar sail

(76) Inventors: Mark A. Klosner, White Plains, NY (US); Kanti Jain, Hawthorne, NY (US)

Correspondence Address: Carl C. Kling;General Counsel, Anvik Corporation, 6 Skyline Drive, Hawthorne, NY, 10532-2165, US

(21) Appl. No.: 10/865,429

(22) Filed: Jun. 10, 2004

(51) Int. Cl. B64G 1/40

(52) U.S. Cl. 244/171.5

(57) ABSTRACT

Low mass-per-unit-area plastic film, preferably polyimide, prepared by a process of controlled treating of a supply of plastic film, possibly with one surface reflectively coated, at a microlithography workstation with included photoablation optics. This treatment achieves significant controlled removal of material in a selected pattern by providing relative motion between untreated plastic film and the workstation's photoablation optics while controlling photoablation of a pattern in the film. The material has a significant quantity of the mass of its plastic removed by photoablation, leaving a tessellated pattern of ridges surrounding individual wells. The resulting low-mass, rip-resistant film retains the general attributes of a large-area plastic film. The treated film also retains its reflective surface, on which amorphous silicon may be deposited. The silicon may be thereafter crystallized, utilizing the same optics, and used for fabrication of microelectronics.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates generally to spacecraft propulsion systems, and more specifically, to photolithography, photoablation, and crystallization techniques as part of a method for large-scale fabrication of highly-reflective reduced-mass-per-area solar sail with integrated microelectronics, MEMS, sensors, etc.

2. Description of Related Art

The solar sail is a propulsive device that uses a thin reflecting foil to deflect sunlight, transferring photon momentum to the sail and thereby accelerating it and the attached payload. Although the pressure per unit area of solar photons is rather small, it can be utilized to accelerate spacecraft to very high velocities-spacecraft with very low mass that are driven by very large sails can take advantage of the steady propulsion offered by the sun to attain speeds that are significantly higher than those achieved with chemical rockets. For example, at a distance of 1 Astronomical Unit the solar pressure is approximately 9 μN/m², a force that will accelerate a one-gram, one-meter-square object at a rate of 9 mm/s². Thus, if the material of a penny (2.5 grams) were spread over an area of one meter and reflected 100% of the incident solar light, it would accelerate to a velocity of 300 m/sec in just one day, assuming that it is steered directly away from the sun. This freely available energy makes solar sails an attractive propulsion system, but the relatively small momentum carried by photons presents a technical challenge to reduce mass.

To achieve useful acceleration of a solar sail by momentum transfer from solar photons, a sail made of very low-mass-per-area materials is required. Since the acceleration of the spacecraft will vary inversely with its mass, large surface area (on the order of hundreds of square meters) would be required effectively to gather sufficient photon momentum to move a spacecraft carrying even a small payload, such as a micro-satellite. A solar sail of this size, in addition to the electronics, communications equipment, sensors, and power sources required to operate the spacecraft and payload, stands to make up a significant part of the overall mass. Further, solar sail material must be resistant to ultraviolet (UV) radiation and easy to carry and deploy into space.

Thus, mass per unit area is a key factor in selecting materials for solar sails. Solar sails have been designed and constructed using, for example, thin films of aluminum around 100 nm thick, deposited on a 5-μm-thick substrate, such as polyester or polyimide. The coated substrate has a density of approximately 7 g/m², with 0.5 g/m² arising from the aluminum and the remaining 6.5 g/m² from the substrate. With an aluminum reflectivity of close to 0.9, these sails accelerate at a rate of approximately 1 mm/s² at 1 AU, and could reach Mars within a year. A prototype of a solar sail deployed at NASA's Jet Propulsion Laboratory uses 3-μm-thick polyester coated with a thin-film aluminum layer achieving a total mass density slightly over 6 g/m².

For interplanetary or interstellar travel, sails will need to be made significantly lighter than this. For example, an all-metal sail with no backing substrate would significantly reduce the mass of the sail. Various means for achieving this have been explored, such as substrates that vaporize upon exposure to UV radiation or the use of UV-degradable adhesion layers which bind the aluminum layer to the underlying substrate. In both cases, exposure to the sun after deployment results in a free standing aluminum foil. While an intermediate step might be simply to reduce the thickness of the underlying substrate, we must note that although polyester is readily available in 0.5 μm thickness, it is not an ideal sail material because it is easily degraded by the sun's ultraviolet radiation, potentially leading to a loss of the structural integrity of the sail; and while polyimide can withstand ultraviolet radiation, it is not available in layers much thinner than 8 μm.

A recently developed material comprised of carbon nanotubes is rigid, strong, and lightweight, only 5 g/m², making it a desirable material for solar sails. However, given that it is rigid, it cannot be packaged in a very small volume like polyester and polyimide, and therefore, solar sails fabricated from the material would likely need to be assembled in space, adding significantly to the complexity of building and deploying the sail. Thus, no currently available material fulfills this role cost-effectively.

Several projects planned by NASA have called for large quantities of highly-reflective, lightweight, deployable, and durable materials. The fabrication method and resulting product presented here provides a cost-effective material sufficiently light, flexible, and UV-tolerant to satisfy this need.

### BRIEF SUMMARY OF THE INVENTION

The object of the invention is to provide a novel solar sail material that addresses the shortcomings of existing materials by producing a low-mass substrate that will survive UV radiation, accommodate the integration of microelectronics, and that can be stored and deployed easily.

A feature of the invention is a weight reducing ablation pattern of ridges and wells formed by removal of material from the original substrate. Due to the laser ablation method employed in this process, this pattern may be any shape or profile suitable to the user's purposes, but polygons, specifically hexagonal ridges, are preferred in many uses.

Another feature of the invention is the ability to deposit and crystallize semiconductor material such as silicon on the substrate, allowing integration of microelectronic components without additional mounting hardware.

An advantage of the invention is its substantial weight savings.

Another advantage of the invention is that its laser ablation process allows the manufacturer flexibility in the ablation pattern in order to suit user-specific needs.

Another advantage of the invention is that the pattern ablated into the material's surface may be selected in order to prevent the propagation of rips in the material.

Another advantage of the invention is that it allows further mass reduction by miniaturizing and integrating electronic components that otherwise might need to be included in the payload, possibly requiring additional wiring and mounting components.

Another advantage of the invention is that it enables increased functionality through the integration of electronic components such as photovoltaic cells and sensors on the surface of the sail.

The invention has been described in its preferred utility as a solar sail, but other objects, features, and advantages of the invention will be apparent from the following written description, claims, abstract, and the annexed drawings.

### BRIEF DESCRIPTION OF DRAWINGS

FIG. 1 is a perspective back view of the preferred embodiment of a solar sail incorporating the invention with a hexagonal grid pattern.

FIG. 2 is a perspective front view of the preferred embodiment of a solar sail incorporating the invention with affixed electronic components.

FIG. 3 is a cross-sectional composite view of the preferred embodiment of a solar sail illustrating a hexagonal grid of cells from which material has been removed to leave flat-bottomed wells and a network of reinforcing structural ridges.

FIG. 4 is a stylized cross-sectional view equivalent to FIG. 3.

FIG. 5 is a schematic of the preferred embodiment of the invention in a prior art high-throughput laser patterning system.

FIG. 6 is a schematic of the preferred embodiment of the invention in a prior art large-area, high-throughput patterning system including a roll-to-roll material supply system and a movable stage with fixed optics.

FIG. 7 is a dual branch imaging apparatus that effectively recycles laser power to crystallize amorphous silicon into single-crystal configurations.

FIG. 8 is an illustration of a silicon crystallization technique by which a quantity of amorphous silicon is changed into a single-crystal configuration suitable for microelectronic fabrication.

### DETAILED DESCRIPTION OF THE INVENTION

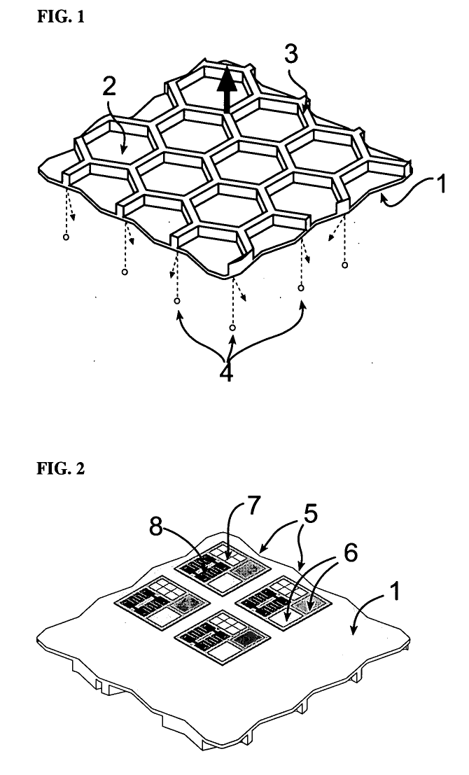

FIG. 1 is a perspective illustration of the solar sail material in its preferred embodiment. The material consists of a substrate layer such as polyimide, coated with a reflective material on its first surface 1, and textured by photoablation on the second surface to leave a tessellated pattern on the second surface. This pattern may be selected by the producer of the material to suit the specific application of the material. The pattern shown in FIG. 1 is a hexagonal grid consisting of flat-bottomed wells denoted by 2 and ridges denoted by 3. A hexagonal grid is suggested here for its relative structural strength and for its tendency not to propagate rips in the material. The reflective coating on the first surface 1 reflects inbound photons 4 emitted by the sun, collecting and imparting their momentum to the sail and thus to the payload.

FIG. 2 is a perspective illustration of the microelectronic integration capability of the invention. Since the first surface 1 remains unablated in this example, an opportunity exists to fabricate microelectronic devices such as photovoltaic cells 7, control circuits 6, and accelerometers 8 on this surface. This integration of components tends to save weight by integrating necessary components that may otherwise require independent packaging, mounting, and/or power supplies. Additional features may be integrated by this technique, as well. Photovoltaic cells and sensors such as accelerometers add additional power and information gathering capability while adding less mass than if these features were included in the system as discrete modules.

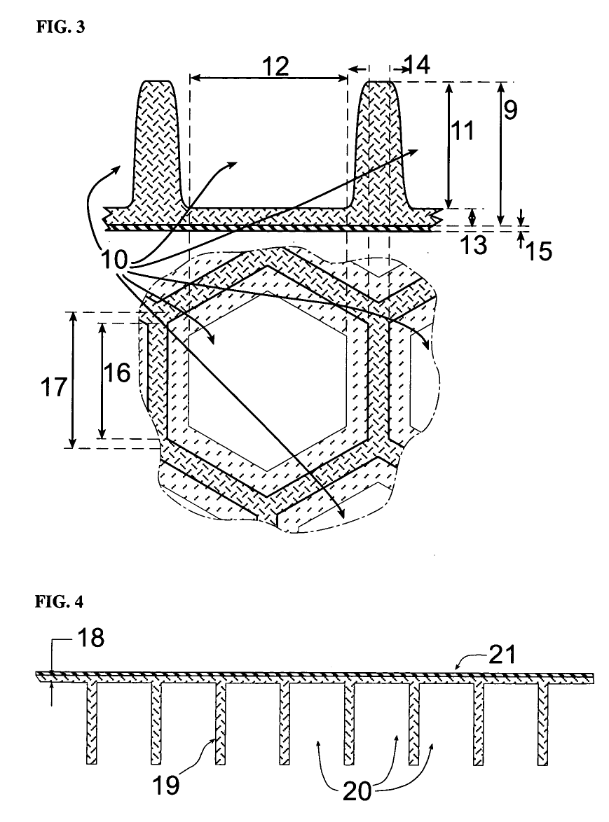

FIG. 3 is a cross-sectional view of the material illustrating the effect of ablation on cross-sectional area and thus mass. The original thickness of the substrate material is shown by arrow 9. Ablated regions 10, with the depth of ablation shown by 11 and the width of ablation shown by 12, leave a well floor thickness of 13 and ridges of height 11 and width 14 attached to a layer of reflective material 15. Below this cross-section is a projection of the cross-section onto an overhead view of a sample hexagonal pattern. This projection shows dimensions of the ablated region translated onto the pattern to illustrate how pattern ablation results in a polygonal well and ridge network.

The layer of reflective material 15, preferably aluminum, is on the surface opposite the ablated surface. This material provides the reflective layer necessary to gather photon momentum. The aluminum layer also will serve as an etch stop if ablation should remove all the plastic at the floor of the well.

The mass reduction realized by the ablation (illustrated in FIG. 3), the primary advantage of such a material, is shown by the following example. Removing a volume V_{R} of substrate material in the rough shape of a hexagonal prism of side-length l_{R} (denoted by 16) and depth h_{R} (denoted by 11) from a larger and thicker solid hexagonal prism of volume V_{S} leaves a well-shaped configuration with volume V_{W}. The larger solid prism with side-length l_{S} (denoted by 17) and height h_{S} (equivalent to the thickness of the substrate film and denoted by 9) has a volume described by
V_{S}=(1.5*l_{S}\sqrt{3})*h_{S}.

The region removed by ablation has a volume of
V_{R}=(1.5*l_{R}\sqrt{3})*h_{R}.

Thus, removing this region leaves a well-shaped substrate cell with volume
V_{W}=V_{S}−V_{R}.

To illustrate the benefit of the invention, a hexagonal ablation pattern with a side length (l_{R}) of 10 μm to a depth (h_{R}) of 7 μm in a 10.5 μm (lₛ) grid of 8-μm-thick (h_{S}) polyimide substrate material would remove a volume of about 181 μm³ from an original solid hexagonal prism of about 218 μm³, resulting in a well with a volume of approximately 36 μm³—a volume (and hence mass) savings of approximately 83% over the unablated substrate material. This 83% savings changes the mass-per-unit-area density of the substrate from about 6.5 g/m² to about 1.1 g/m².

[image]

FIG. 4 is a stylized version of FIG. 3 illustrating a cross-section of a repeating pattern. The diagram includes the thickness of the well floors 18, the ridges 19 separating the wells (made by the ablated areas 20), and the reflective coating 21.

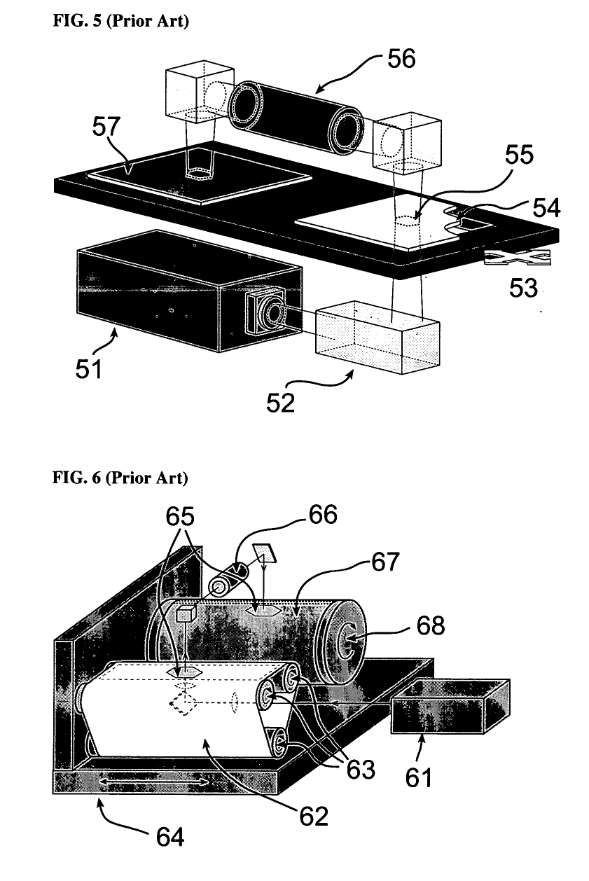

FIG. 5 is a schematic diagram illustrating a prior art system by which the material described above can be fabricated inexpensively in large-area batches. This process utilizes a technique in which large quantities of film material 57 are supplied to a lithographic stage 53 providing relative motion between the material and the laser optics 56. The laser optics 56 carry a beam emitted by the laser 51 and shaped by an illumination system 52 and a patterning system. The patterning system illustrated here is a mask 54 that modifies the beam to include the desired pattern, here a hexagonal area 55. The laser beam ablates masses of substrate in a pattern 55 that may be selected by the user of the process. The hexagonal grid described above exemplifies one variety of such a pattern.

FIG. 6 is a schematic diagram that illustrates a prior art method of supplying a flexible large-area substrate material 67 to the stage for ablation as described above. In the method shown here, a beam from a laser 61 is guided through a flexible mask 62 on rollers 63 containing a pattern 65 and through optics 66 to the surface of the material 67. This system utilizes a movable stage 64 so the material 67 may be scanned across its width with the pattern 65 and a feed system to advance the material 67 to a take-up roll 68 where pattern-ablated material may be stored. The necessary relative motion between the material 67 and the optics 66 may also be implemented by movable optics scanning over a fixed stage.

As shown in FIG. 1 above, the ridges resulting from the ablation of materials such as polyimide do not have sharp edges. Thus, the material may be rolled onto itself without concern of new layers cutting or being cut by earlier material.

The low temperature at which this process occurs does not risk melting the substrate material, which further facilitates large-scale production; large sheets may be produced without the risk of ruining an entire sheet by melting one portion.

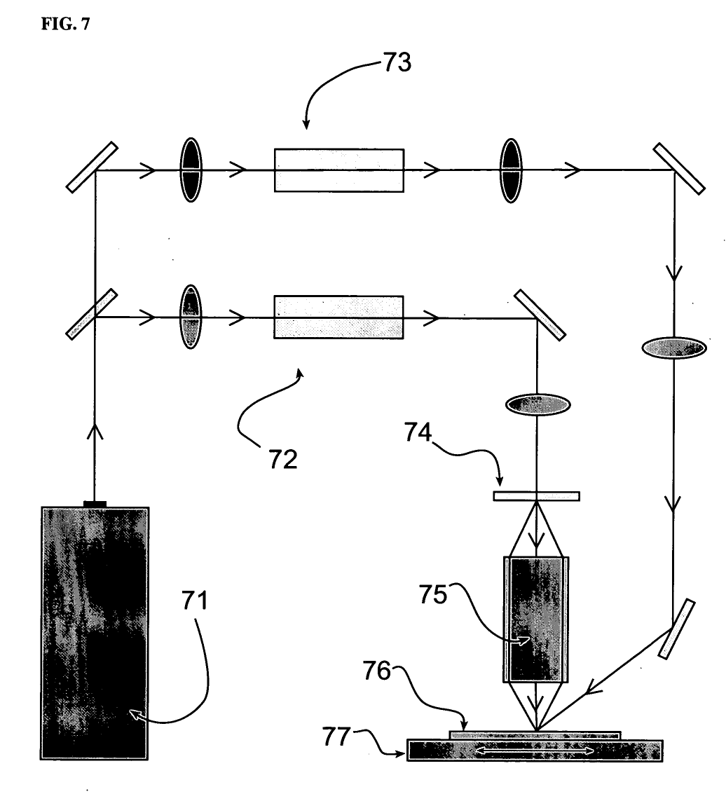

FIG. 7 illustrates the crystallization of silicon effected by laser radiation. This invention allows the crystallization of silicon on the substrate material. If a surface of the film 76 is coated with amorphous silicon, the same optical workstation utilized for the ablation phase of the method can crystallize the silicon into a suitable configuration for microelectronic components. The preferred embodiment of the invention includes a laser 71 and two optical branches, imaging 72 and non-imaging 73. The imaging branch 72 focuses the beam, directs it through a mask 74 and projection optics 75 to perform high-resolution exposures on the substrate 76. The non-imaging branch 73 performs flood irradiation that overlaps the region exposed by the imaging branch 72. The substrate 76 and stage 77 move relative to the optics described above to allow repeated exposures of the pattern onto the substrate 76.

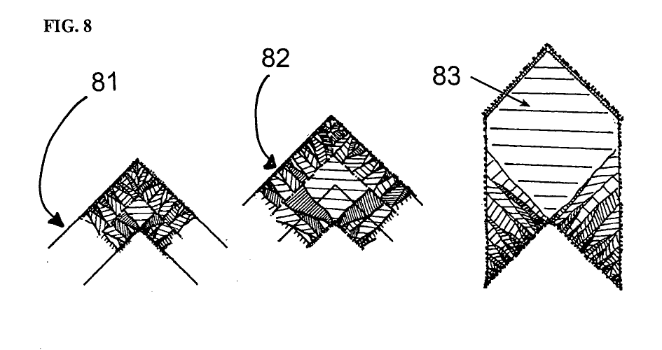

FIG. 8 shows the crystallization of silicon facilitated by the technique illustrated in FIG. 7. The radiation produced by the workstation can be shaped into a chevron pattern 81 and scanned over the amorphous silicon 82 on the surface of the substrate film to create a single-crystal silicon region 83. This enables specified quantities of single-crystal silicon to be precisely and inexpensively placed on the substrate in such a way that electronic components can be located on the surface of the substrate itself.

The invention has been shown preferably in the form of a solar sail with its mass reduced by a polygonal ablation pattern and with microelectronic components integrated into the surface of the substrate. It will be clear that the modifications described above and other modifications, whether described as alternatives or not, will be apparent, without departing from the spirit and scope of the invention, as described in the following claims:

1. Low mass-per-unit-area plastic film prepared by a process of controlled treating of a supply of untreated plastic film, having a first surface and second surface, opposed across a finite mass of plastic film material, at a microlithography workstation in which photoablation optics is an effective approach to accomplish significant controlled removal of material in a selected pattern controlled by a control means,
characterized by the following steps:
a) Providing relative lateral motion between said first surface of the supply of untreated plastic film and said photoablation optics at such microlithography workstation;
b) Controlling photoablation of a pattern of depressions and surrounding ridges in such a plastic film;
whereby the treated plastic film retains said first surface and has a significant quantity of its mass removed by photoablation leaving a set of ridges surrounding a set of wells, the treated plastic thus being significantly reduced in mass while retaining the general attributes of a large-area plastic film.

2. Low mass-per-unit-area solar sail made from plastic film prepared by a process according to claim 1,
further characterized by:
adding a mirrored layer to said first surface to reflect solar radiation and consequently utilize the propulsive effect of solar radiation against the reflective layer on the solar sail.

3. Low mass-per-unit-area plastic film prepared by a process according to claim 2,
further characterized by:
adding a layer of microelectronic devices to said mirrorized solar sail for use during actual deployment.

4. Low mass-per-unit-area plastic film prepared by a process according to claim 1,
further characterized in that:
said relative motion occurs by motion of said photoablation optics.

5. Low mass-per-unit-area plastic film prepared by a process according to claim 1,
further characterized in that:
said relative motion occurs by motion of a portion of said plastic film.

6. Low mass-per-unit-area plastic film prepared by a process according to claim 1,
further characterized in that:
said ridges are rounded.

7. Low mass-per-unit-area plastic film prepared by a process according to claim 1,
further characterized in that:
said wells have closed bottoms to retain the integrity of first surface.

8. Low mass-per-unit-area plastic film prepared by a process according to claim 7,
further characterized in that:
said wells are closed polygons.

9. Low mass-per-unit-area plastic film prepared by a process according to claim 8,
further characterized in that:
said wells are hexagonal.

10. Low mass-per-unit-area plastic film prepared by a process according to claim 2,
further characterized in that:
said wells have open bottoms, exposing said mirrored layer as an etch stop.

11. A process of controlled treating of a supply of untreated plastic film, having a first surface and a second surface opposed across a finite mass of plastic film material, at a microlithography workstation in which photoablation optics is an effective approach to accomplish significant controlled removal of material in a selected pattern controlled by a control means,
characterized by the following steps:
a) Providing relative lateral motion between said first surface of the supply of untreated plastic film and said photoablation optics at such microlithography workstation;
b) Controlling photoablation of a pattern of depressions and surrounding ridges in such a plastic film;
whereby the treated plastic film retains said first surface during removal by photoablation of a significant majority of its mass, leaving a set of ridges surrounding a set of wells, the treated plastic thus being significantly reduced in mass while retaining the general attributes of a large-area plastic film.

12. A solar sail, to provide a combined propulsion means and microelectronics support panel, having a low-mass support film of solar-resistant plastic with solar-reflection surface treatment forming a solar-reflection surface,
characterized by:
a) a supporting matrix of polygonal ridges, arrayed substantially across the entire area of such solar sail, opposite such solar reflection surface treatment, integral to such film,
whereby such ridges provide beam strength and rip-resistance to such solar sail while the total mass of such solar sail is minimized as the effect of removal of plastic to selected a depth.

13. A solar sail according to claim 12,
further characterized in that:
microelectronic devices are arrayed on the solar-reflection surface,
whereby such solar sail is effective both to provide propulsion power by taking propulsive energy from solar photons, and is also effective to provide support for an array of microelectronic devices.
